(19) United States
(12) Patent Application Publication
(10) Pub. No.: US 2006/0236554 A1
(43) Pub. Date: Oct. 26, 2006

(54) Number one jib tool

(76) Inventor: Larry William Peterson, Iowa City, IA (US)

Correspondence Address: Larry William Peterson, 1412 Lower Muscatine Road, Iowa City, IA, 52240, US

(21) Appl. No.: 11/475,234

(22) Filed: Jun. 23, 2006

Related U.S. Application Data
(63) Continuation-in-part of application No. 10/189,293, filed on Jul. 2, 2002, now abandoned.

(51) Int. Cl. G01D 21/00

(52) U.S. Cl. 33/613

(57) ABSTRACT

A spacer system is provided for positioning studs preparatory to securing the studs with top and bottom plates to form a wall. The system employs a starter spacer having a first set of stud notches for positioning studs at the comer portion of the wall. A continuation spacer with a second set of stud notches then is deployed to position the rest of the wall studs.

### STATEMENT REGARDING FEDERALLY SPONSORED RESEARCH OR DEVELOPMENT

Not Applicable

### AUTHORIZATION PURSUANT TO 37 C.F.R. § 1.71(d)(e)

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

This invention relates generally to the field of home construction, particularly to construction of building walls, and more particularly to tools employed to proper placement of wall studs preparatory to securing the same with top and bottom plates.

2. Description of the Related Art

### BRIEF SUMMARY OF THE INVENTION

The present invention discloses a spacer system for positioning studs preparatory to fixing the same with plates.

A spacer system is provided for positioning studs preparatory to securing the studs with top and bottom plates to form a wall. The system employs a starter spacer having a first set of stud notches for positioning studs at the comer portion of the wall. A continuation spacer with a second set of stud notches then is deployed to position the rest of the wall studs.

Other objects, advantages, and novel features of the present invention will become apparent from the following detailed description of the invention when considered in conjunction with the accompanying drawings.

### BRIEF DESCRIPTION OF THE SEVERAL VIEWS OF THE DRAWINGS

FIG. 1 is a side elevational view of the starter spacer of the spacer system of this invention;

FIG. 2 is a top plan view of the starter spacer;

FIG. 3 is an end elevation of the starter spacer;

FIG. 4 is a reduced, perspective view, of the continuation spacer of the spacer system of this invention;

FIG. 5 is a further reduced, side elevational view of the continuation spacer;

FIG. 6 is a further reduced, top plan view of the continuation spacer;

FIG. 7 is an end elevational view of the continuation spacer;

FIG. 8 is an enlarged, fragmentary, perspective view showing use of the starter spacer to position studs at the corner of the wall;

FIG. 9 is an enlarged, fragmentary, elevational view showing use of the starter spacer to form the comer of a wall;

FIG. 10 is an enlarged, fragmentary, top plan view showing the starter spacer deployed at formation of the wall comer;

FIG. 11 is a reduced, perspective view showing deployment of the continuation spacer to form the remainder of the wall; and

FIG. 12 is a top plan view showing use of the continuation spacer to form the rest of the wall.

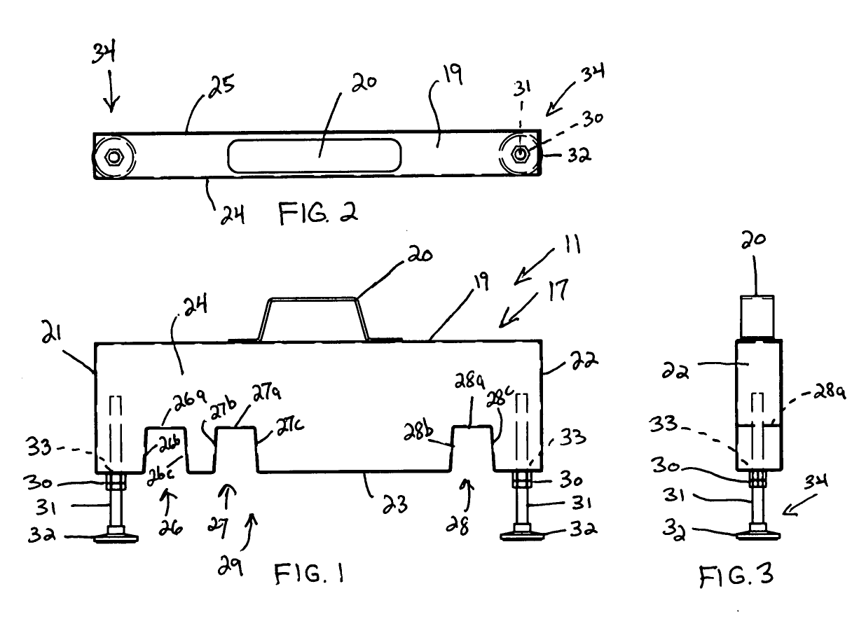

### DETAILED DESCRIPTION OF THE INVENTION

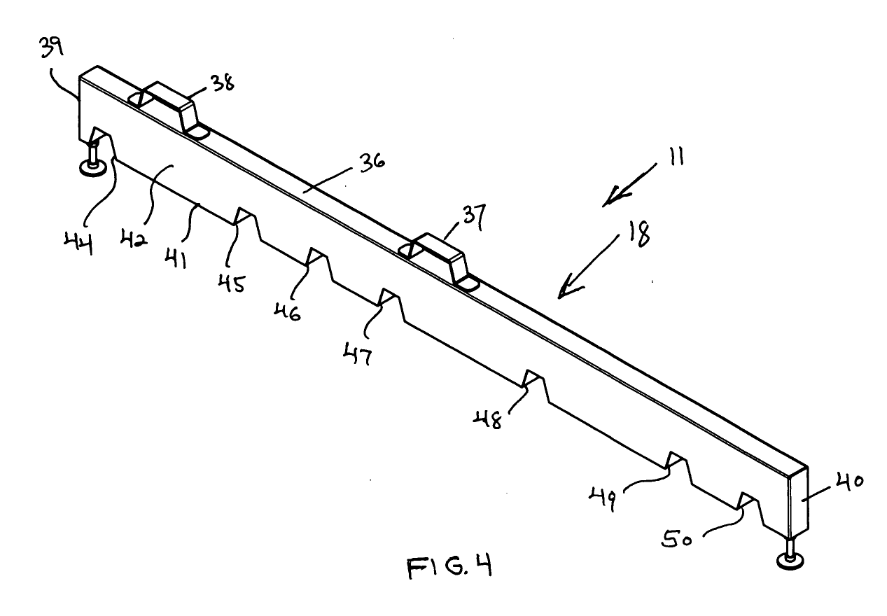

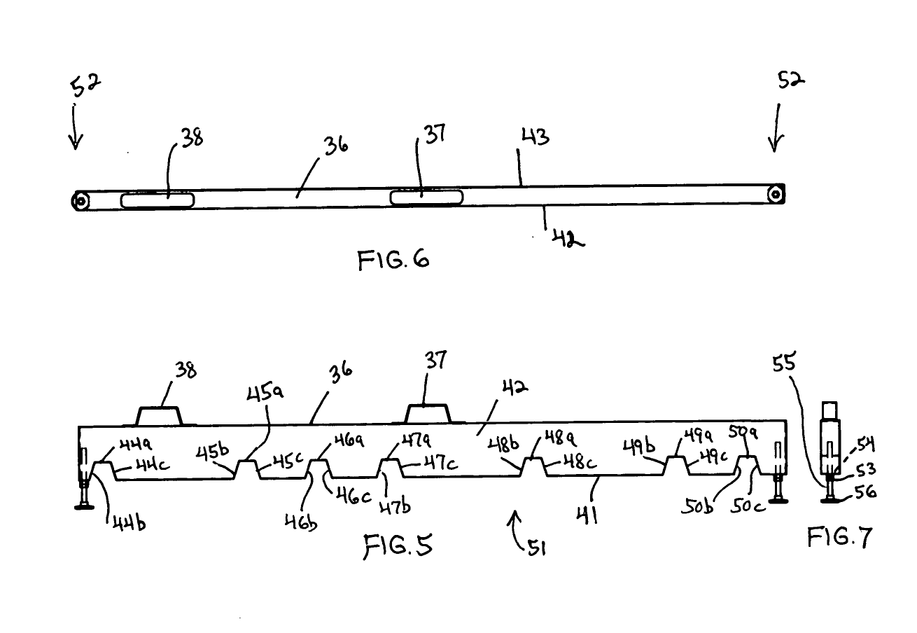

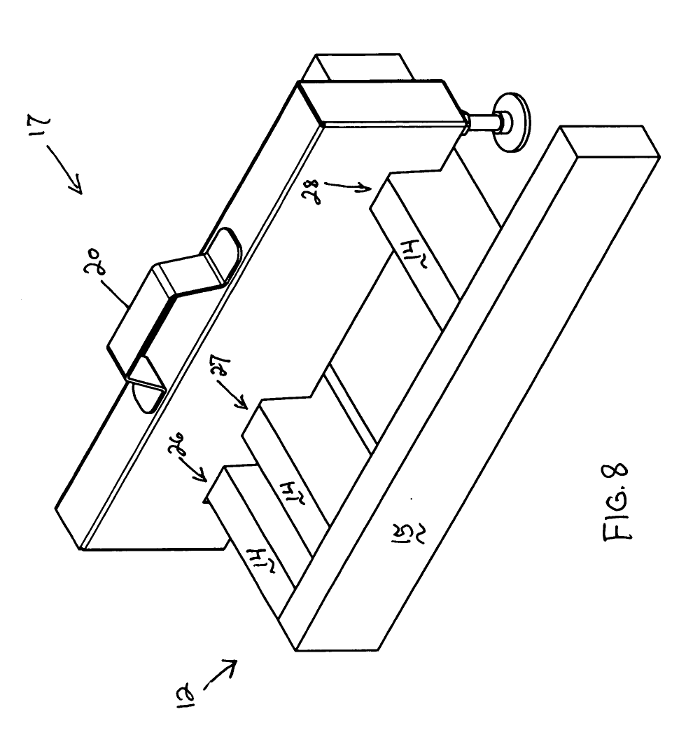

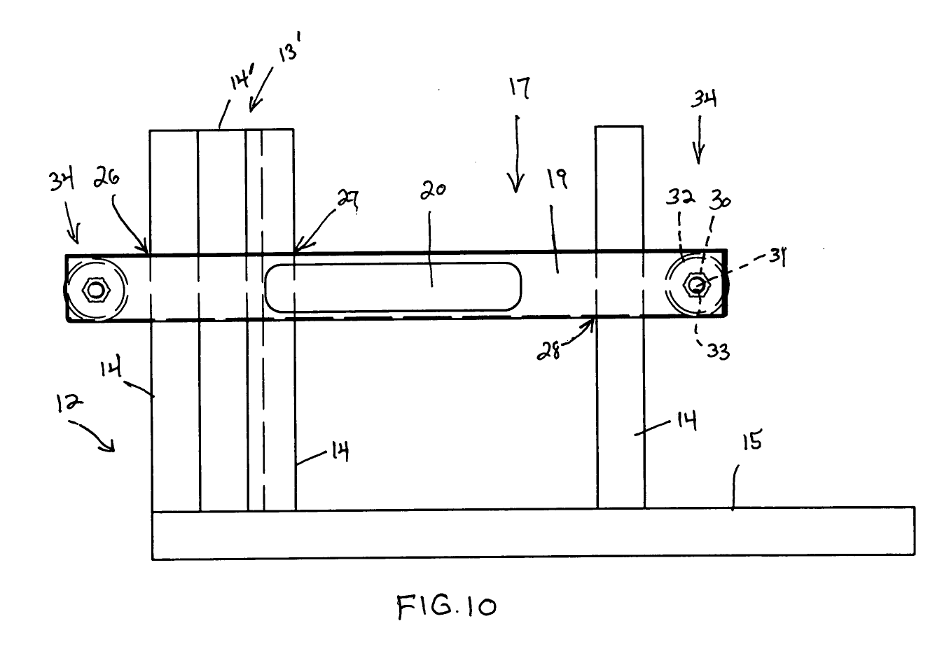

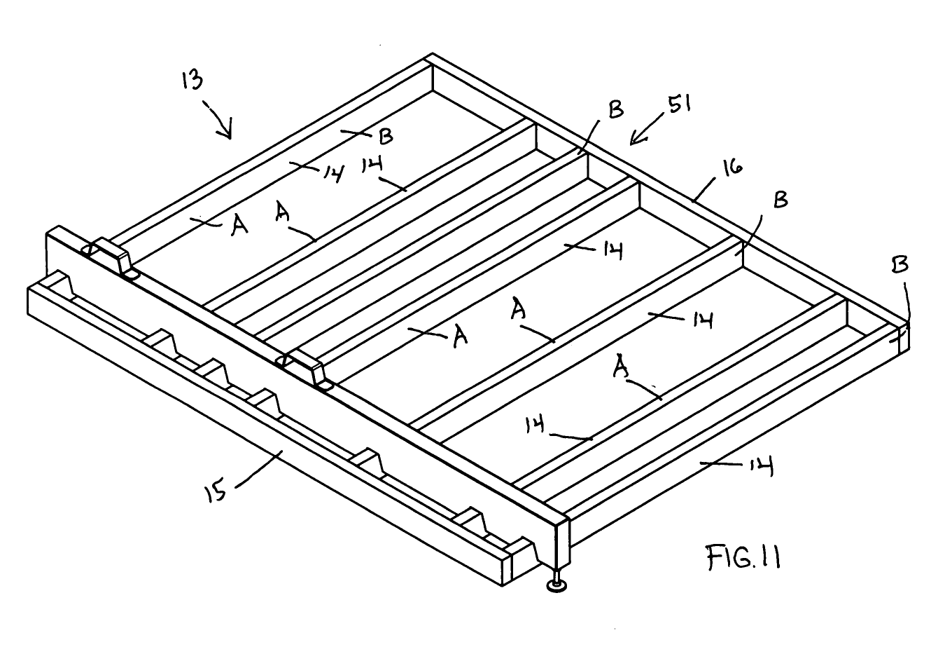

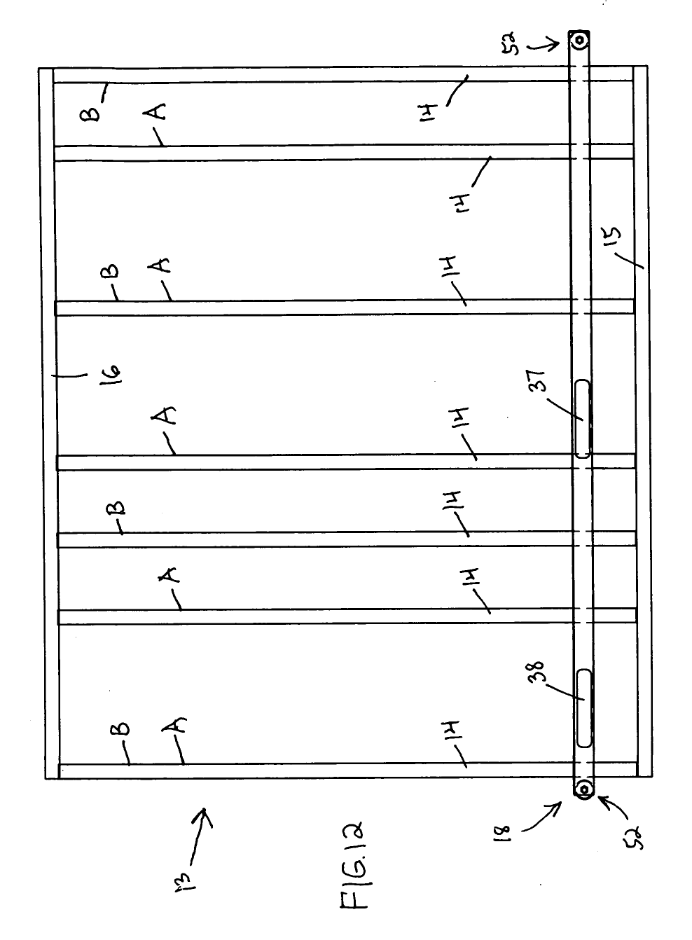

Referring now to the drawings, wherein like reference numerals designate identical or corresponding parts throughout the several views, the spacer system of this invention is shown generally at (11) in FIGS. 1 and 4. The spacer system (11) is shown applied to formation of a wall corner (12) at FIGS. 8-10, and an entire wall (13) at FIGS. 11, 12, comprised of studs (14), joined by bottom and top plates (15, 16).

The spacer system (11) more particularly includes a starter spacer (17), see FIG. 1, and a continuation spacer (18), see FIG. 4. Both starter spacer (17) and continuation spacer (18), preferably are tubular, that is, hollow in construction.

Referring again to FIG. 1, starter spacer (17) includes a top surface (19) having a u-shaped handle (20)affixed thereto, intermediate the ends thereof. Generally parallel, front and rear end surfaces (21, 22) depend from opposite ends of top surface (19). A bottom surface (23) extends between the lower ends of front end and rear end surfaces (21, 22). Left and right side surfaces (24, 25) extend between the top, end and bottom surfaces (19, 21, 22, 23) to form the hollow starter spacer (17).

A plurality of stud notches (26, 27, 28) are formed into the starter spacer (17). More particularly, left and right side surfaces (24, 25) have a plurality of transversely aligned, longitudinally spaced apart cutouts formed therein. The bottom surface (23) extends upwardly into the cutouts. More particularly, bottom surface (23) includes a central wall (26a) and diverging front end rear walls (26b and 26c) which form stud notch (26). Likewise, bottom surface (23) includes a central wall (27a) joined to diverging front and rear walls (27b, 27c) to form stud notch (27). Further, bottom surface (23) includes a central wall (28a) contiguous with diverging front and rear walls (28b, 28c) to form stud notch (28). Stud notch (26) is located adjacent front end surface (21). Stud notch (27) is located adjacent stud notch (26), and stud notch (28) is located adjacent rear end surface (22). The stud notches (26, 27, 28) together define a first set of positions (29) for wall studs (14).

The starter spacer (17) further includes nuts (30) affixed to bottom surface (23), adjacent front and rear end surfaces (21, 22). The nuts (30) are aligned over bores (33) formed through bottom surface (23). Bolts (31) thread through the nuts (30) and bores (33) and at the free ends thereof have ground engaging heads (32). The starter spacer (17) thereby is provided with a pair of adjustable legs (34).

The continuation spacer (18) also includes a top surface (36). A first handle (37), generally u-shaped, is fixed to top surface (36) intermediate the ends thereof. A second, u-shaped handle (38) is fixed to top surface (36) adjacent one end thereof. First and second end surfaces (39, 40) are generally parallel and depend from opposite ends of top surface (36). Bottom surface (41) extends between the lower ends of first and second end surfaces (39, 40). First and second side surfaces (42, 43) extend between top, first end, second end, and bottom surface (36, 39, 40, 41) to form the hollow continuation spacer (18).

A plurality of stud notches (44-50) are formed in continuation spacer (18). More specifically, a plurality of longitudinally spaced, transversely aligned cutouts are formed in first and second side surfaces (42, 43). The bottom surface (41) extends upwardly into these cutouts. Each stud notch (44-50) includes a central wall (44a-50a) generally parallel to top surface (36). Each stud notch (44-50) further includes first walls (44b-50b) and second walls (44c-50c) diverging from each other as they extend downwardly away from the central walls (44a-50a). The stud notches (44-50) together are employed to define a second set of positions (51) for wall studs (14).

The continuation spacer (18) further includes a pair of adjustable legs (52). These legs (52) are disposed adjacent the first and second end surfaces (39, 40). Each adjustable leg (52) includes a nut (53) fixed to bottom surface (41) adjacent one of the end surfaces (39, 40). The nuts (53) are aligned over bores (54) formed through bottom surface (41). Bolts (55) thread through the nuts (53) and bores (54) and at the free end thereof have ground engaging heads (56).

Application of the spacer system (11) to the formation of a wall frame (13) from studs (14) as shown at FIGS. 8-12. Initially, a plurality of studs (14) are deployed on the ground in a generally parallel relationship with respect to each other. The user adjusts the legs (34) of starter spacer (17) and the legs (52) of continuation spacer (18) to accommodate for whether the studs (14) are 2×4, 2×6, or some other dimension. The user then grasps the handle (20) of starter spacer (17) and positions the same against the studs (14) which are to form one end of the wall (13). The first three studs (14) assume the first position set (29) established by stud notches (26, 27, 28). The studs (14) are guided by diverging walls (26b-26c, 27b-27c, and 28b-28c) into abutment against central walls (26a, 26b, and 26c) respectively. See FIGS. 8-10. The bottom plate (15) then is affixed to the starter studs (14). See FIG. 8. The starter spacer (17) then is removed.

The user next grasps handles (37, 38) of the continuation spacer (18) and positions the continuation spacer against the plurality of studs (14). Stud notch (44) engages the starter stud (14) formerly positioned by stud notch (28) of the starter spacer (18). Certain of the remaining stud notches (45-50) form a second set of positions (51), according to type of stud employed, which determines spacing between studs, and location of proposed doors and windows, which further determines the second set of positions (51). The studs (14) are guided by diverging walls (44b-44c, 45b-45c, 46b-46c, 47b-47c, 48b-48c, 49b-49c, and/or 50b-50c) against central walls (44a, 45a, 46a, 47a, 48a, 49a, and/or 50a). These additional studs (14) are pressed against the bottom plate (15) and attached as by nails to the same. The continuation spacer (18) is employed as many times as necessary to complete the length of the wall (13).

After all the additional studs (14) are affixed to the bottom plate (15) the wall (13) is completed by attaching the top plate (16). See FIG. 11. When completing the wall (13) after the bottom plate (15) has been attached to the studs (14), the starter spacer (17) and continuation spacer (18) are employed in the same order as before. More specifically, the starter spacer (17) again is deployed over the first three studs (14) in the first position set (29) adjacent the free ends of the studs (14). The top plate (16) then is attached to the first three studs (14), such as by nails. The starter spacer (17) then is removed. The continuation spacer (18) then is positioned against the studs (14) as before, but adjacent the free ends thereof. Once the free ends of the studs (14) are properly aligned, the studs (14) are fixed to the top plate (16). The continuation spacer (18) again is employed as many times as necessary to complete the length of the wall (13), steadying the free ends of the studs (14) in the second set of positions (51) prior to fixing the studs to the top plate (16).

Referring again to FIG. 11, one second set of positions (51) is designated by A. An alternate second set of positions (51) is designated by B. When the wall studs (14) employed are of 2×4″ dimension, the spacing between studs (14) is 16″ on center. That spacing is designated A. When the wall studs (14) employed are of 2×6″ dimension, the spacing between studs (14) is 24″ on center. That spacing is designated B. Other sets of positions (51) may be used to provide spacings for door and window placements.

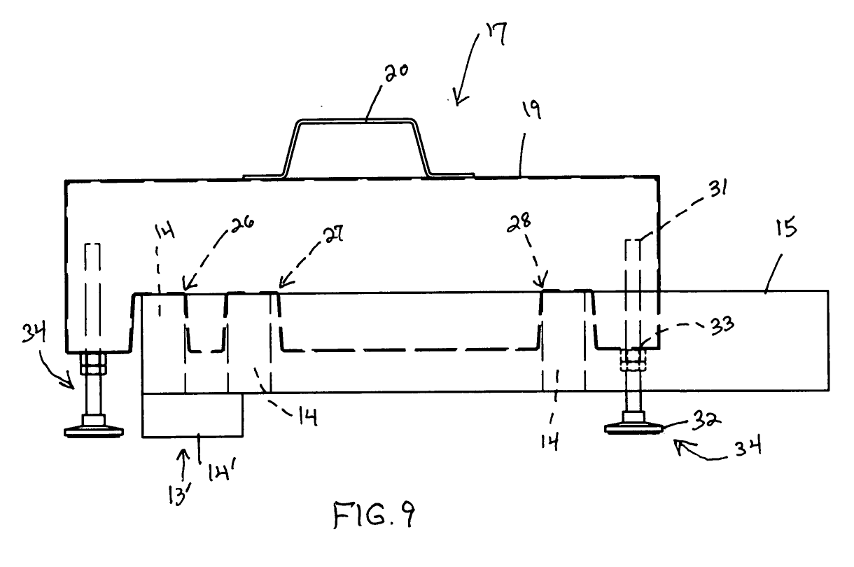

Referring to FIGS. 9 and 10, 14¹designates the end stud (14) of the second complete wall 13¹. Stud 14¹ abuts the starter studs (14) positioned by the first two stud notches (26, 27) of the starter spacer (17). Those two studs (14), fixed as by nails or the like to stud 14¹ form a proper wall comer for receiving sheeting (not shown) affixed to the interior edges of studs (14, 14¹).

The industrial applicability of the spacer system (11) is believed to be apparent from the foregoing description. Although only exemplary embodiments of the invention have been described in detail above, those skilled in the art will readily appreciate that many modifications are possible without materially departing from the novel teachings and advantages of this invention. Accordingly, all such modifications are intended to be included within the scope of this invention as defined in the following claims.

In the claims, means-plus-function clauses are intended to cover both equivalent structures and structural equivalents of the structures described herein as performing the claimed function.

I claim:

1. A spacer for studs comprising:
A frame having top and bottom and forward and rearward sides and right and left ends, said frame being elongated from right to left, said frame having a row of notches spaced various distances from said right end, said notches extending upwardly from the bottom of said frame and completely through said frame from said forward and rearward sides of said frame, each of said notches being of a size for receiving an edge portion of a common wall studding when such studding is rested on a horizontal surface, said frame being substantially hollow for lightness and maneuverability, said frame having vertical forward and rearward walls, said frame having horizontal top and bottom walls, said frame having two elongated sections each of which have a vertical straight flange and a horizontal straight flange, means connecting said sections together to form a rectangular configuration when seen in a cross-section normal to said frame, a pair of legs spaced along said frame, means attaching said legs to said frame in a manner permitting the bottoms of said legs to be adjusted to be at various distances from said frame, one of said notches being at an end of said row of notches, said one notch being larger than the others for receiving a studding group of a kind used in a comer of a building.

2. The spacer of claim 1 having said notches have walls which diverge toward their lower ends so as to more easily receive studs.

3. A spacer for studs comprising:
first side wall with first top and first bottom edges;
second side wall spaced apart from said first side wall and having second top and second bottom edges;
transverse top wall spanning said first and second side walls between said top edges;
a plurality of stud notches formed into said side walls and extending upwardly from said bottom edges, each stud notch having an internal notch wall and notch side walls continuously diverging while extending from each end of said internal notch wall to said bottom edges, said notch side walls forming stud receiving openings along said bottom edges, said notches in said first side wall being transversely aligned with said notches in said second side wall.

4. The spacer of claim 3 further wherein a first stud-group notch is formed into said first side wall adjacent a first side wall end, a second stud-group notch is formed into said second side wall adjacent a second side wall end, said first and second stud-group notches being transversely aligned, each stud-group notch having an internal stud-group notch wall and stud-group notch side walls extending from each end of said internal stud-group notch wall to said bottom edge and forming a stud-group receiving opening in said bottom edge, said stud-group receiving opening being of greater dimension than said stud receiving openings.

5. The spacer of claim 4 further wherein at least one liner extends between transversely aligned notches in said first and second side walls.

6. The spacer of claim 4 further wherein said side and top walls form separate first-used and second-used spacers, said stud-group notches being included on said first-used spacer.

7. A method for forming a wall comprising:
deploying a plurality of studs in generally parallel relationship to each other;
positioning a starter spacer against said plurality of studs, said starter spacer defining a first set of positions, said plurality of studs fitting said first set of positions;
fixing a plate to said plurality of studs;
removing said starter spacer;
positioning a continuation spacer against said plurality of studs, said continuation spacer defining a second set of positions;
fitting a second plurality of studs into said second set of positions;
fixing said second plurality of studs to said plate.

8. The method of claim 7 further comprising fixing a second plate to said first and second pluralities of studs.

9. The method of claim 8 wherein said plate is fixed at a plurality of first ends of said first and second plurality of studs, and said second plate is fixed at a plurality of second ends of said first and second plurality of studs.
